(19) United States
(12) Patent Application Publication
(10) Pub. No.: US 2013/0135491 A1
(43) Pub. Date: May 30, 2013

(54) ELECTRONIC CAMERA

(71) Applicant: SANYO ELECTRIC CO., LTD., Osaka (JP)

(72) Inventor: Hideto Shimaoka, Uji City (JP)

(73) Assignee: SANYO ELECTRIC CO., LTD., Osaka (JP)

(21) Appl. No.: 13/673,156

(22) Filed: Nov. 9, 2012

(30) Foreign Application Priority Data
Nov. 24, 2011 (JP) 2011-256765

(51) Int. Cl. H04N 5/232

(52) U.S. Cl. CPC H04N 5/23229
USPC 348/222.1

(57) ABSTRACT

An electronic camera includes an imager. An imager outputs an electronic image corresponding to an optical image captured on an imaging surface. An acquirer acquires the electronic image outputted from the imager, in response to a user operation. A controller controls permitting/restricting a process of the acquirer by determining a commonality between an object captured by the imaging surface at a time point at which the user operation is accepted and an object captured by the imaging surface in a reference attitude. A creator creates attitude information indicating an attitude of the imaging surface at the time point at which the user operation is accepted when the process of the acquirer is permitted by the controller. A reproducer reproduces the electronic image acquired by the acquirer with reference to the attitude information created by the creator.

### CROSS REFERENCE OF RELATED APPLICATION

The disclosure of Japanese Patent Application No.2011-256765, which was filed on Nov. 24, 2011, is incorporated herein by reference.

### BACKGROUND OF THE INVENTION

1. Field of the Invention

The present invention relates to an electronic camera, and in particular, relates to an electronic camera which acquires an electronic image corresponding to an optical image captured on an imaging surface, in response to a user operation, and creates attitude information indicating an attitude of an imaging surface at a time point at which the user operation is accepted.

2. Description of the Related Art

According to one example of this type of camera, when a plurality of images are photographed by changing an orientation of the imaging surface under a panorama mode, orientation information detected by an orientation sensor is appended to each of the photographed plurality of images. Upon reproducing, an image which is assigned with orientation information equivalent to the orientation of the imaging surface is detected from among the photographed plurality of images, and the detected image is displayed on a display portion.

However, in the above-described camera, it is not assumed that a common object is photographed in a plurality of viewpoints, and therefore, a performance of recording and reproducing an image representing the common object is limited.

### SUMMARY OF THE INVENTION

An electronic camera according to the present invention comprises: an imager which outputs an electronic image corresponding to an optical image captured on an imaging surface; an acquirer which acquires the electronic image outputted from the imager, in response to a user operation; a controller which controls permitting/restricting a process of the acquirer by determining a commonality between an object captured by the imaging surface at a time point at which the user operation is accepted and an object captured by the imaging surface in a reference attitude; a creator which creates attitude information indicating an attitude of the imaging surface at the time point at which the user operation is accepted when the process of the acquirer is permitted by the controller; and a reproducer which reproduces the electronic image acquired by the acquirer with reference to the attitude information created by the creator.

According to the present invention, a camera control program recorded on a non-transitory recording medium in order to control an electronic camera provided with an imager which outputs an electronic image corresponding to an optical image captured on an imaging surface, the program causing a processor of the electronic camera to perform the steps, comprises: an acquiring step of acquiring the electronic image outputted from the imager, in response to a user operation; a controlling step of controlling permitting/restricting a process of the acquiring step by determining a commonality between an object captured by the imaging surface at a time point at which the user operation is accepted and an object captured by the imaging surface in a reference attitude; a creating step of creating attitude information indicating an attitude of the imaging surface at the time point at which the user operation is accepted when the process of the acquiring step is permitted by the controlling step; and a reproducing step of reproducing the electronic image acquired by the acquiring step with reference to the attitude information created by the creating step.

According to the present invention, a camera control method executed by an electronic camera provided with an imager which outputs an electronic image corresponding to an optical image captured on an imaging surface, comprises: an acquiring step of acquiring the electronic image outputted from the imager, in response to a user operation; a controlling step of controlling permitting/restricting a process of the acquiring step by determining a commonality between an object captured by the imaging surface at a time point at which the user operation is accepted and an object captured by the imaging surface in a reference attitude; a creating step of creating attitude information indicating an attitude of the imaging surface at the time point at which the user operation is accepted when the process of the acquiring step is permitted by the controlling step; and a reproducing step of reproducing the electronic image acquired by the acquiring step with reference to the attitude information created by the creating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an assigned state of an evaluation area EVA in an imaging surface;

FIG. 4 is an illustrative view showing one example of a configuration of a register referred to in the embodiment in FIG. 2;

FIG. 5 is an illustrative view showing one example of a configuration of another register referred to in the embodiment in FIG. 2;

FIG. 6 is an illustrative view showing one example of an attitude assumed by a camera housing in a pseudo 3D mode;

FIG. 7(A) is an illustrative view showing one example of an object image photographed in the pseudo 3D mode;

FIG. 7(B) is an illustrative view showing another example of the object image photographed in the pseudo 3D mode;

FIG. 7(C) is an illustrative view showing still another example of the object image photographed in the pseudo 3D mode;

FIG. 7(C) is an illustrative view showing yet another example of the object image photographed in the pseudo 3D mode;

FIG. 8 is an illustrative view showing one example of a configuration of still another register referred to in the embodiment in FIG. 2;

FIG. 9 is an illustrative view showing one example of a configuration of yet another register referred to in the embodiment in FIG. 2;

FIG. 10 is an illustrative view showing one example of an attitude assumed by the camera housing in a reproducing mode;

FIG. 11(A) is an illustrative view showing one example of a reproduced image;

FIG. 11(B) is an illustrative view showing another example of the reproduced image;

FIG. 11(C) is an illustrative view showing still another example of the reproduced image;

FIG. 11(D) is an illustrative view showing yet another example of the reproduced image;

FIG. 12 is a flowchart showing one portion of behavior of a CPU applied to the embodiment in FIG. 2;

FIG. 13 is a flowchart showing another portion of behavior of the CPU applied to the embodiment in FIG. 2;

FIG. 14 is a flowchart showing still another portion of behavior of the CPU applied to the embodiment in FIG. 2;

FIG. 15 is a flowchart showing yet another portion of behavior of the CPU applied to the embodiment in FIG. 2;

FIG. 16 is a flowchart showing another portion of behavior of the CPU applied to the embodiment in FIG. 2;

FIG. 17 is a flowchart showing still another portion of behavior of the CPU applied to the embodiment in FIG. 2;

FIG. 18 is an illustrative view showing a state that an external appearance of another embodiment is viewed from above;

FIG. 19 is a flowchart showing one portion of behavior of the CPU applied to another embodiment; and

FIG. 20 is a block diagram showing a configuration of another embodiment of the present invention.

### DETAILED DESCRIPTION OF THE PREFERRED EMBODIMENTS

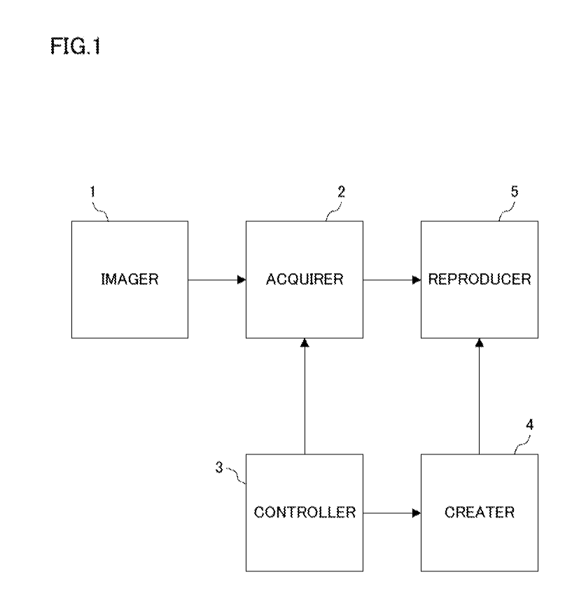

With reference to FIG. 1, an electronic camera according to one embodiment of the present invention is basically configured as follows: An imager 1 outputs an electronic image corresponding to an optical image captured on an imaging surface. An acquirer 2 acquires the electronic image outputted from the imager 1, in response to a user operation. A controller 3 controls permitting/restricting a process of the acquirer 2 by determining a commonality between an object captured by the imaging surface at a time point at which the user operation is accepted and an object captured by the imaging surface in a reference attitude. A creator 4 creates attitude information indicating an attitude of the imaging surface at the time point at which the user operation is accepted when the process of the acquirer 2 is permitted by the controller 3. A reproducer 5 reproduces the electronic image acquired by the acquirer 2 with reference to the attitude information created by the creator 4.

The process of acquiring the electronic image in response to the user operation is permitted/restricted by determining commonality between the object captured by the imaging surface at the time point at which the user operation is accepted and the object captured by the imaging surface in the reference attitude. Thereby, it becomes possible to restrictively acquire an electronic image in which a common object is appeared, and a recording performance is improved. Moreover, the attitude information indicating the attitude of the imaging surface at the time point at which the user operation is accepted is created in association with acquiring the electronic image, and the acquired electronic image is reproduced with reference to the created attitude information. Thereby, a reproducing performance is improved.

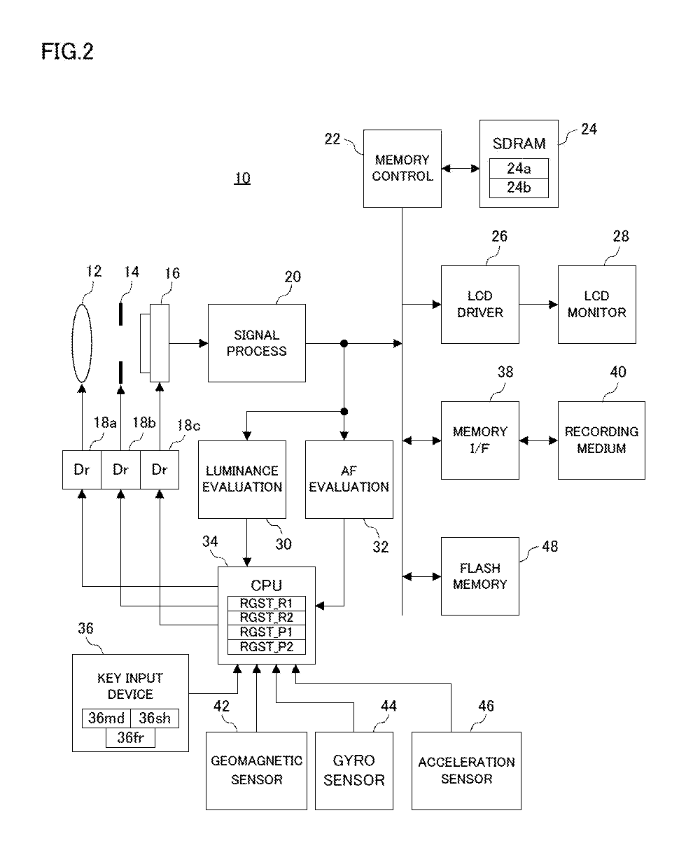

With reference to FIG. 2, a digital camera 10 according to one embodiment includes a focus lens 12 and an aperture unit 14 driven by drivers 18a and 18b, respectively. An optical image that underwent the focus lens 12 and the aperture unit 14 enters, with irradiation, an imaging surface of an imaging device 16, and is subjected to a photoelectric conversion. Thereby, electric charges representing a scene captured on the imaging surface are produced.

When a camera mode is selected by a mode selector switch 36md arranged in a key input device 36, in order to execute a moving-image taking process under an imaging task, a CPU 34 commands a driver 18c to repeat an exposure procedure and an electric-charge reading-out procedure.

In response to a vertical synchronization signal Vsync outputted from an SG (Signal Generator) not shown, the driver 18c exposes the imaging surface and reads out the electric charges produced on the imaging surface in a raster scanning manner. From the imaging device 16, raw image data that is based on the read-out electric charges is cyclically outputted.

A signal processing circuit 20 performs processes, such as white balance adjustment, color separation, and YUV conversion, on the raw image data outputted from the imaging device 16, and writes YUV formatted-image data produced thereby, into a moving-image area 24a of an SDRAM 24 through a memory control circuit 22.

An LCD driver 26 reads out the image data stored in the moving-image area 24a through the memory control circuit 22, and drives an LCD monitor 28 based on the read-out image data. As a result, a real-time moving image (a live view image) representing the scene captured on the imaging surface is displayed on a monitor screen.

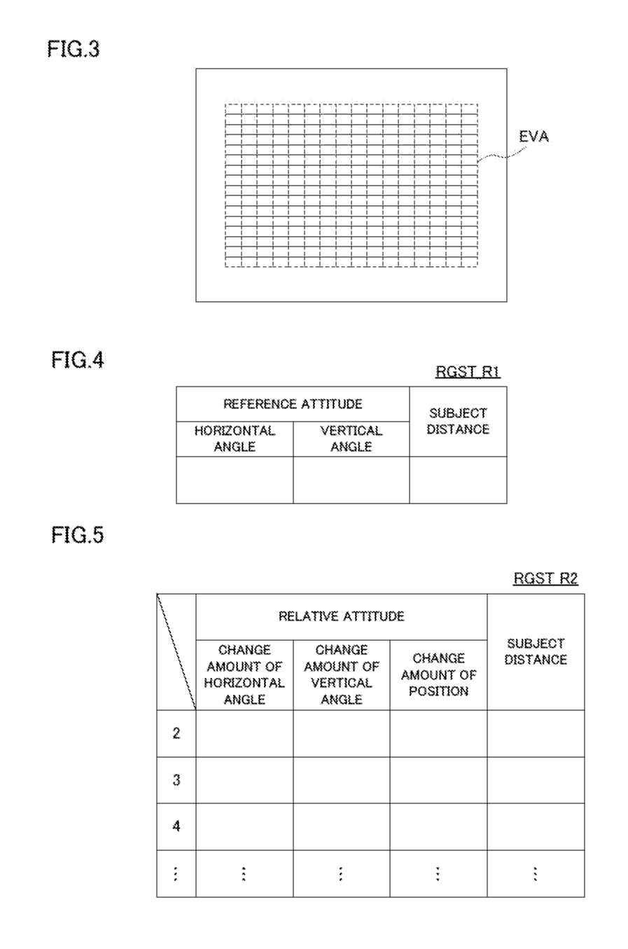

With reference to FIG. 3, an evaluation area EVA is assigned to a center of the imaging surface. The evaluation area EVA is divided into 16 portions in each of a horizontal direction and a vertical direction; therefore, a total of 256 divided areas form the evaluation area EVA.

A luminance evaluating circuit 30 integrates Y data belonging to the evaluation area EVA out of Y data outputted from the signal processing circuit 20, for each divided area, and outputs 256 integral values (256 luminance evaluation values). An integrating process is executed at every time the vertical synchronization signal Vsync is generated, and the 256 luminance evaluation values are outputted from the luminance evaluating circuit 30 in synchronization with the vertical synchronization signal Vsync.

Moreover, an AF evaluating circuit 32 integrates a high frequency component of the Y data belonging to the evaluation area EVA out of the Y data outputted from the signal processing circuit 20, for each divided area, and outputs 256 integral values (256 AF evaluation values). The integrating process is also executed at every time the vertical synchronization signal Vsync is generated, and the 256 AF evaluation values are outputted from the AF evaluating circuit 32 in synchronization with the vertical synchronization signal Vsync.

When a shutter button 36sh arranged in the key input device 36 is in a non-operated state, the CPU 34 repeatedly executes a simple AE process in order to calculate an appropriate EV value based on the luminance evaluation values outputted from the luminance evaluating circuit 30. An aperture amount and an exposure time period that define the calculated appropriate EV value are set to the drivers 18b and 18c, respectively. As a result, a brightness of a live view image displayed on the LCD monitor 28 is adjusted approximately.

When the shutter button 36sh is half-depressed, in order to calculate an optimal EV value based on the luminance evaluation values outputted from the luminance evaluating circuit 30, the CPU 34 executes a strict AE process. Similarly to described above, an aperture amount and an exposure time period that define the calculated optimal EV value are set to the drivers 18b and 18c, respectively. Thereby, the brightness of the live view image displayed on the LCD monitor 28 is adjusted strictly.

Subsequently, the CPU 34 executes an AF process. The focus lens 12 is moved in an optical-axis direction, and the AF evaluation values outputted from the AF evaluating circuit 32 are repeatedly taken in parallel with a moving process for the focus lens 12. A focal point is searched based on the taken AF evaluation values, and the focus lens 12 is placed at the discovered focal point. Thereby, a sharpness of the live view image displayed on the LCD monitor 28 is improved.

Under the camera mode, a normal mode and a pseudo 3D mode are prepared as a taking mode. The taking mode is also switched by an operation of the mode selector switch 36md, alternatively.

When the shutter button 36sh is full-depressed in a state where the normal mode is selected, the CPU 34 executes a still-image taking process without any condition. In contrary, when the shutter button 36sh is full-depressed in a state where the pseudo 3D mode is selected, the CPU 34 executes the still-image taking process on the condition that a flag FLGerror described later indicates “0”. As a result of the still-image taking process, image data representing a scene at a time point at which the AF process is completed is evacuated from the moving-image area 24a to a still-image area 24b.

Moreover, the CPU 34 executes following processes under a recording control task parallel with the imaging task. When the taking mode at a time point at which the shutter button 36sh is operated is the normal mode, the CPU 34 creates an image file containing a file header and the image data secured in the still-image area 24b, and stores the created image file in a recording medium 40 through a memory I/F 38. In the recording medium 40, a predetermined folder for the normal mode is preliminarily installed, and the image file created under the normal mode is contained in the predetermined folder.

When the taking mode at a time point at which the shutter button 36sh is operated is the pseudo 3D mode, the CPU 34 newly creates a pseudo 3D folder in the recording medium 40, opens the created pseudo 3D folder, and sets a variable K indicating the number of image files contained in the pseudo 3D folder to “0”.

When the shutter button 36sh is half-depressed in a state where the variable K indicates “0”, the CPU 34 detects a horizontal angle (=angle of orientation) and a vertical angle (=elevation angle) that define a current orientation of the camera housing, based on outputs of a geomagnetic sensor 42 and a gym sensor 44, and registers the detected horizontal angle and vertical angle as the reference attitude in a register RGST R1 shown in FIG. 4. Furthermore, the CPU 34 calculates a distance to a main subject (=a focused subject) based on a placement of the focus lens 12 at a time point at which the AF process is completed, and registers the calculated distance as a subject distance in the register RGST_R1.

Thereafter, when the shutter button 36sh is fully-depressed, the CPU 34 creates an image file containing a file header and the image data secured in the still-image area 24b, and stores the created image file in the recording medium 40 through the memory I/F 38. The image file is contained in the newly created pseudo 3D folder, and the variable K is incremented after a storing process is completed.

When the shutter button 36sh is half-depressed in a state where the variable K indicates a value equal to or more than “1”, the CPU 34 detects change amounts of the horizontal angle and the vertical angle that define the attitude of the camera housing, based on the outputs of the geomagnetic sensor 42 and the gym sensor 44 and a description of the register RGST_R1, detects a change amount of a position of the camera housing based on output of an acceleration sensor 46, and registers these detected change amounts as a relative attitude in a register RGST_R2 shown in FIG. 5. The relative attitude is described in a K-th column.

Moreover, the CPU 34 calculates a distance to the main subject based on a placement of the focus lens 12 at a time point at which the AF process is completed, and registers the calculated distance as the subject distance in the register RGST_R2. The subject distance is also described in the K-th column.

Thereafter, the CPU 34 determines whether or not a subject same as the main subject captured in the reference attitude is captured as a main subject at a time of operating the shutter button 36sh this time, based on the reference attitude and subject distance registered in the register RGST_R1 and the relative attitude and subject distance described in the K-th column of the register RGST_R2.

Specifically, the determining process is equivalent to a process of determining whether or not a logical AND condition under which a straight line linking the main subject to the imaging surface in the reference attitude intersects or crosses in multilevel a straight line linking the main subject to the imaging surface in the K-th relative attitude, and a difference between the subject distance in the reference attitude and the subject distance in the K-th relative attitude falls below a reference is satisfied.

The flag FLGerror is set to any one of “1” and “0” corresponding to a result of the determining process. That is, when the main subject captured at a time of operating the shutter button this time is different from the main subject captured in the reference attitude, the flag FLGerror is set to “1”. In contrary, when the main subject captured at a time of operating the shutter button this time is common to the main subject captured in the reference attitude, the flag FLGerror is set to “0”.

When the shutter button 36sh is fully-depressed in a state where the flag FLGerror indicates “0” (=a state where a commonality of the main subject is secured), the CPU 34 additionally writes a relative attitude registered in the K+1th column of the register RGST_R2 in a file header as the attitude information. Furthermore, the CPU 34 stores an image file containing the file header thus created and the image data secured in the still-image area 24b in response to the shutter button 36sh being fully-depressed, in the recording medium 40 through the memory I/F 38. The image file is contained in the newly created pseudo 3D folder, and the variable K is incremented after the storing process.

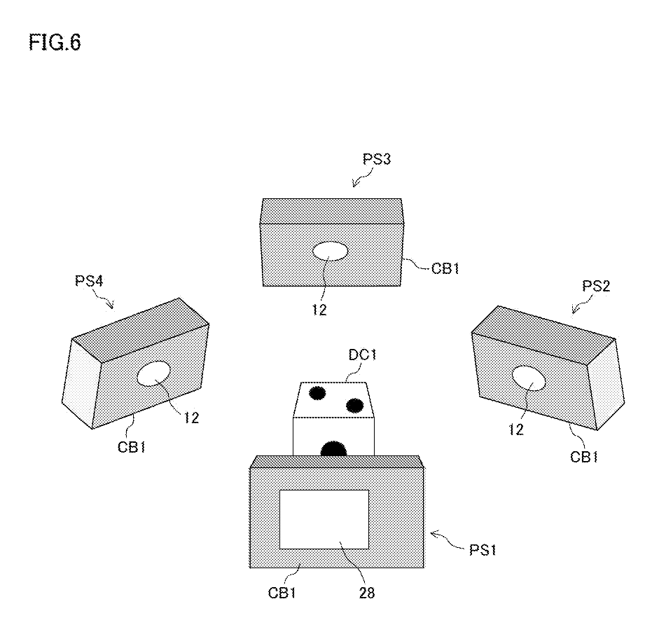

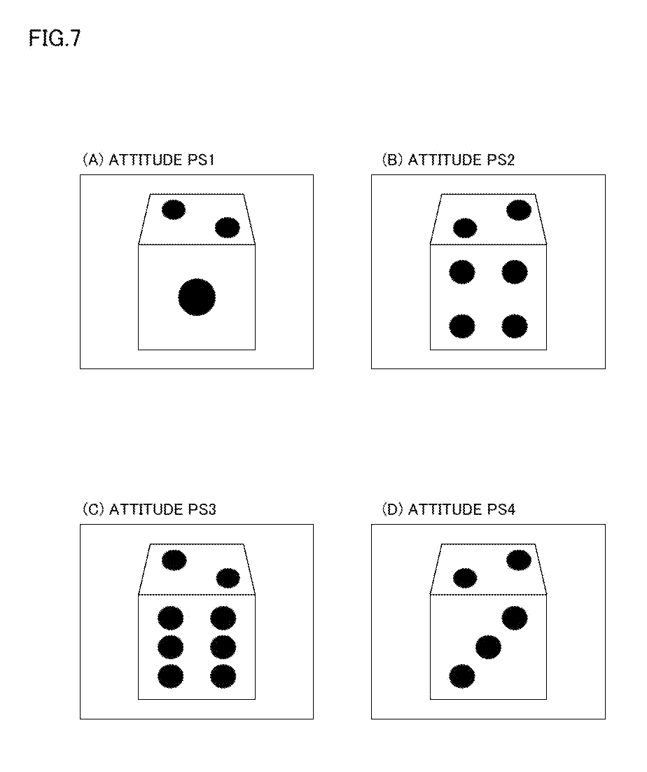

Thus, when the shutter button 36sh is operated after placing a camera housing CB1 in order of attitudes PS1 to PS4 shown in FIG. 6, a dice DC1 is photographed in four viewpoints different from one another. The dice DC1 is photographed corresponding to: the attitude PS1 as shown in FIG. 7 (A); the attitude PS2 as shown in FIG. 7 (B); the attitude PS3 as shown in FIG. 7 (C); and the attitude PS4 as shown in FIG. 7 (D).

Here, the attitude PS1 is detected as the reference attitude, and each of the attitudes PS2 to PS4 is detected as the relative attitude. Thus, a relative attitude representing the attitude PS2 is described in a header of an image file containing image data shown in FIG. 7 (B), a relative attitude representing the attitude PS3 is described in a header of an image file containing image data shown in FIG. 7 (C), and a relative attitude representing the attitude PS4 is described in a header of an image file containing image data shown in FIG. 7 (D).

The pseudo 3D folder in an opened state is closed or deleted when the normal mode is selected by the mode selector switch 36md. That is, the pseudo 3D folder is closed when the normal mode is selected in a state where at least one image file is contained in the pseudo 3D folder, and is deleted when the normal mode is selected in a state where no image file exists in the pseudo 3D folder.

When a reproducing mode is selected by the mode selector switch 36md, the CPU 34 executes following processes under a reproducing task.

Firstly, the CPU 34 executes a process of selecting any one of a plurality of folders recorded in the recording medium 40. When the selected folder is the predetermined folder for the normal mode, the CPU 34 designates the latest image file contained in the predetermined folder, and commands the memory I/F 38 to reproduce the designated image file.

The memory OF 38 reads out the image data contained in the designated image file from the recording medium 40 so as to write the read-out image data into the still-image area 24b of the SDRAM24 through the memory control circuit 22. The LCD driver 26 reads out the image data thus transferred to the still-image area 24b through the memory control circuit 22 so as to drive the LCD monitor 28 based on the read-out image data. As a result, a reproduced image is displayed on the monitor screen.

When a forward operation is performed by a forward/backward button 36fr arranged in the key input device 36, the CPU 34 commands the memory I/F 38 to reproduce a subsequent image file contained in the predetermined folder. In contrary, when a backward operation is performed by the forward/backward button 36fr, the CPU 34 commands the memory I/F 38 to reproduce a prior image file contained in the predetermined folder. As a result, the image displayed on the LCD monitor 28 is updated to another image.

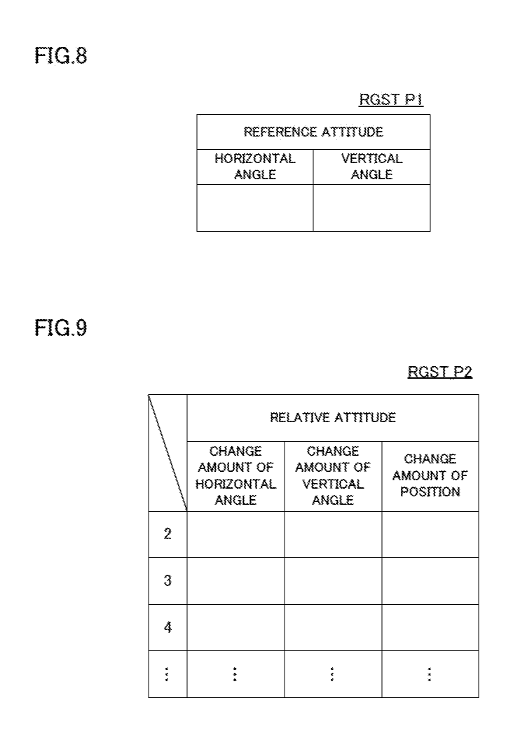

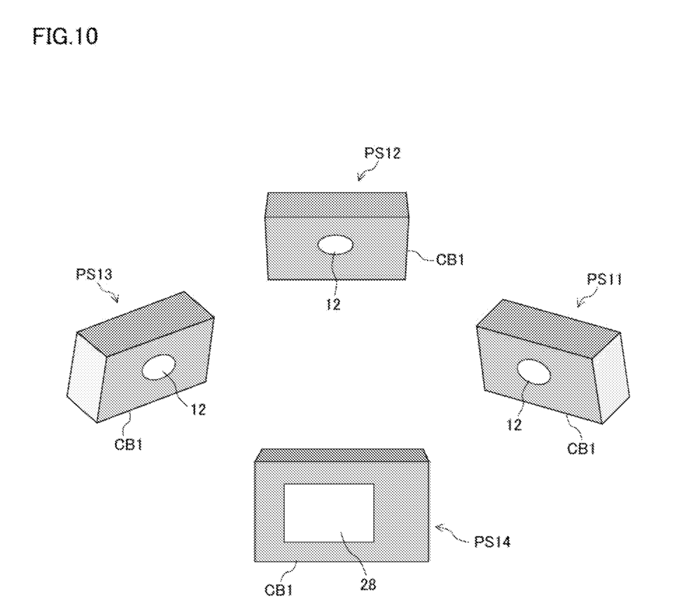

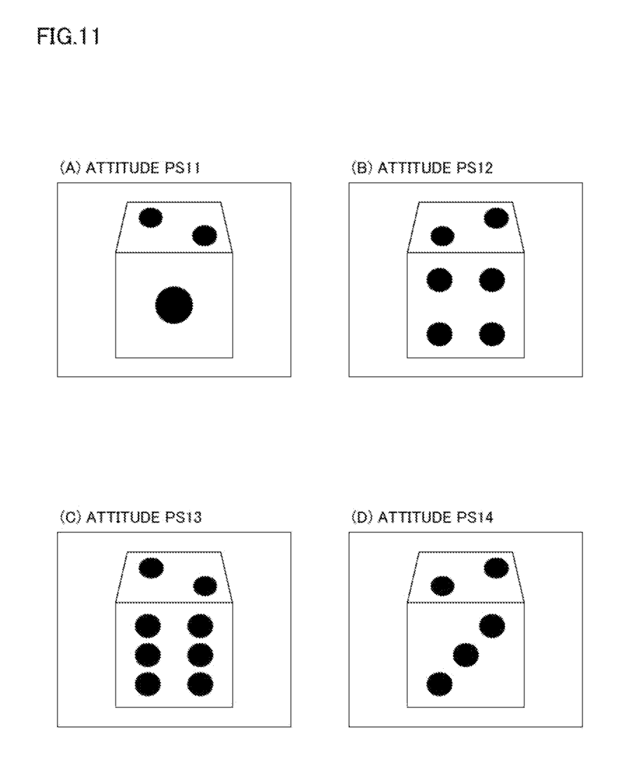

When the selected folder is the pseudo 3D folder, the CPU 34 detects a horizontal angle and a vertical angle that define a current orientation of the camera housing CB1, based on outputs of the geomagnetic sensor 42 and the gym sensor 44, and registers the detected horizontal angle and vertical angle as the reference attitude in a register RGST_P1 shown in FIG. 8. Furthermore, the CPU 34 reads out attitude information (=relative attitude) from the second and subsequent image files contained in the pseudo 3D folder so as to register the read-out attitude information in a register RGST_P2 shown in FIG. 9.

Subsequently, the CPU 34 designates a head image file contained in the pseudo 3D folder, and commands the memory I/F 38 to reproduce the designated image file. As a result, a reproduced image that is based on image data contained in the head image file is displayed on the LCD monitor 28.

Thereafter, the CPU 34 detects change amounts of the horizontal angle and the vertical angle that define the attitude of the camera housing CB1, based on the outputs of the geomagnetic sensor 42 and the gym sensor 44 and a description of the register RGST_P1, detects a change amount of a position of the camera housing CB1 based on output of the acceleration sensor 46, and defines these detected change amounts as a relative attitude at a current time point.

A relative attitude coincident with the defined relative attitude at the current time point is searched from among one or at least two relative attitudes registered in the register RGST_P2. When the coincident relative attitude is discovered, the CPU 34 designates an image file of description resource of the discovered relative attitude, and commands the memory I/F 38 to reproduce the designated image file. As a result, the image displayed on the LCD monitor 28 is updated to another image.

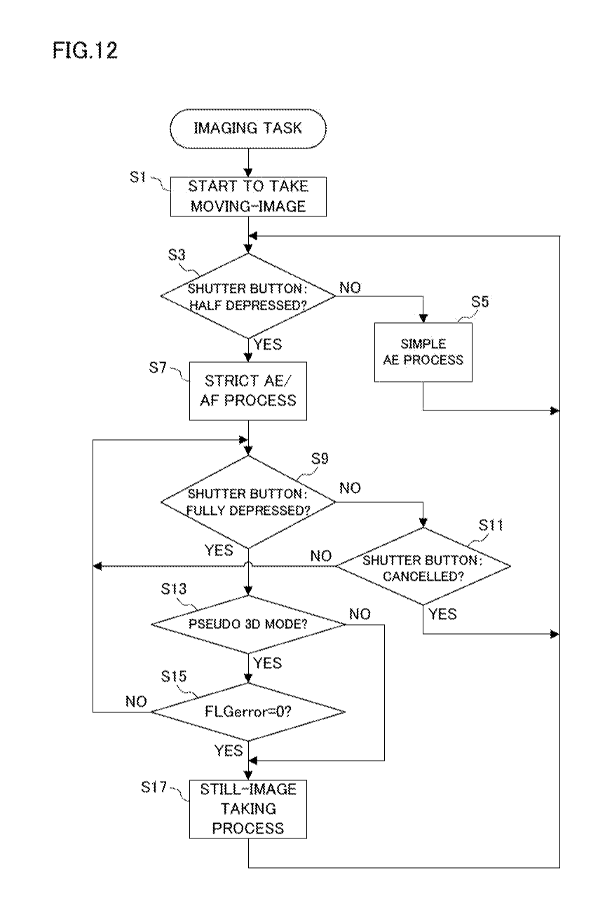

Thus, when the pseudo 3D folder is selected in a state where the camera housing CB1 is placed in an attitude PS11 shown in FIG. 10 and the attitude of the camera housing CB1 is transitioned between “PS11” to “PS14”, an image shown in FIG. 11 (A) is reproduced corresponding to the attitude PS 11, an image shown in FIG. 11(B) is reproduced corresponding to the attitude PS12, an image shown in FIG. 11(C) is reproduced corresponding to the attitude PS 13, and an image shown in FIG. 11 (D) is reproduced corresponding to the attitude PS 14.

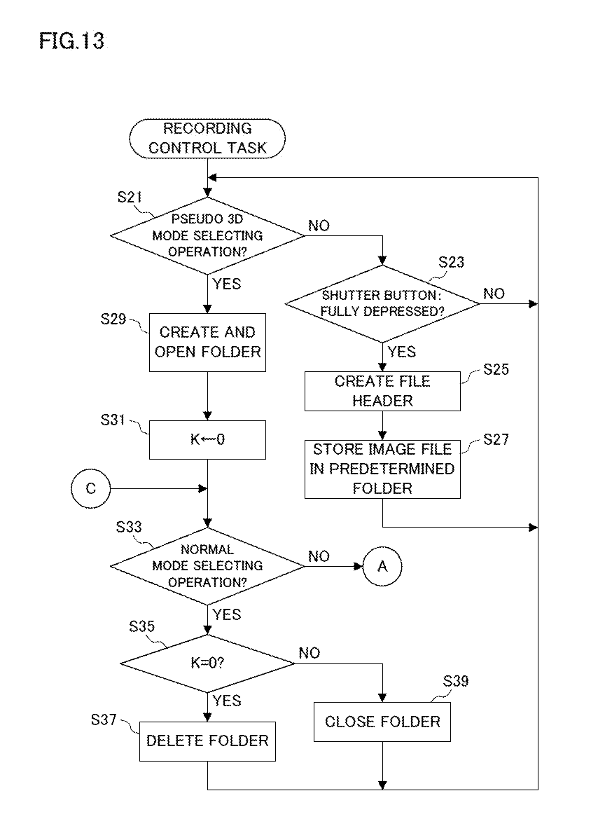

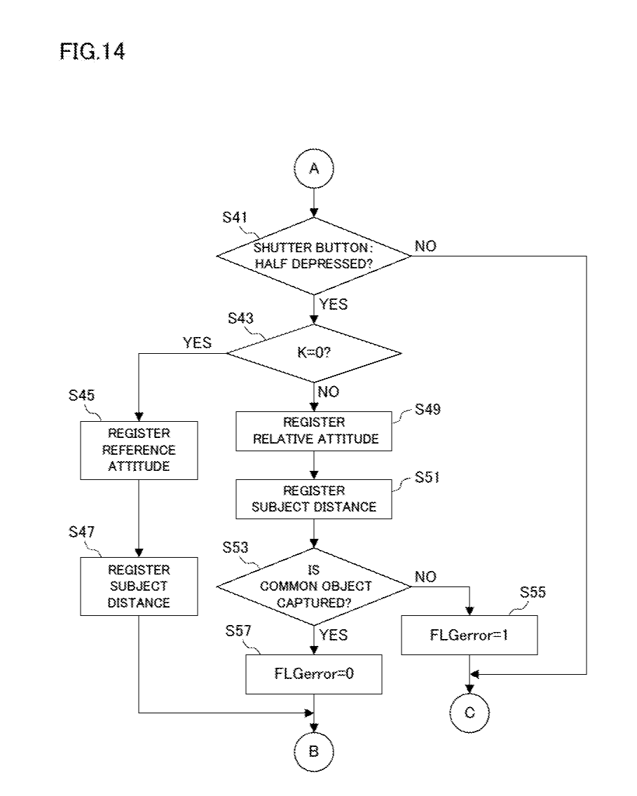

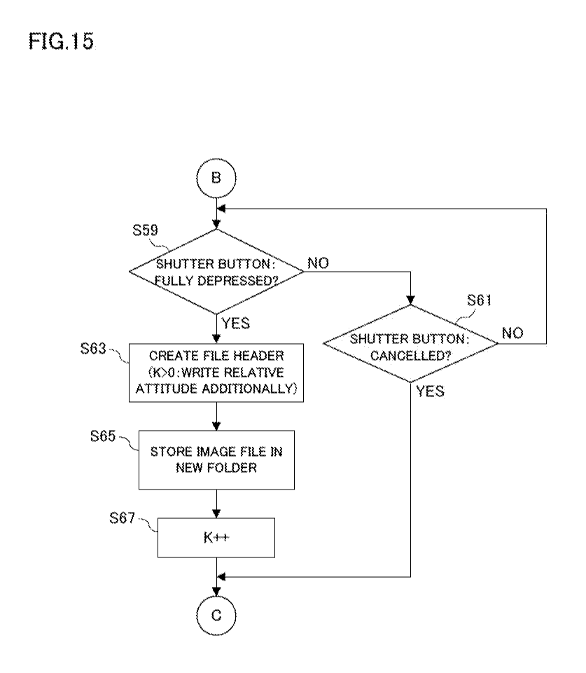

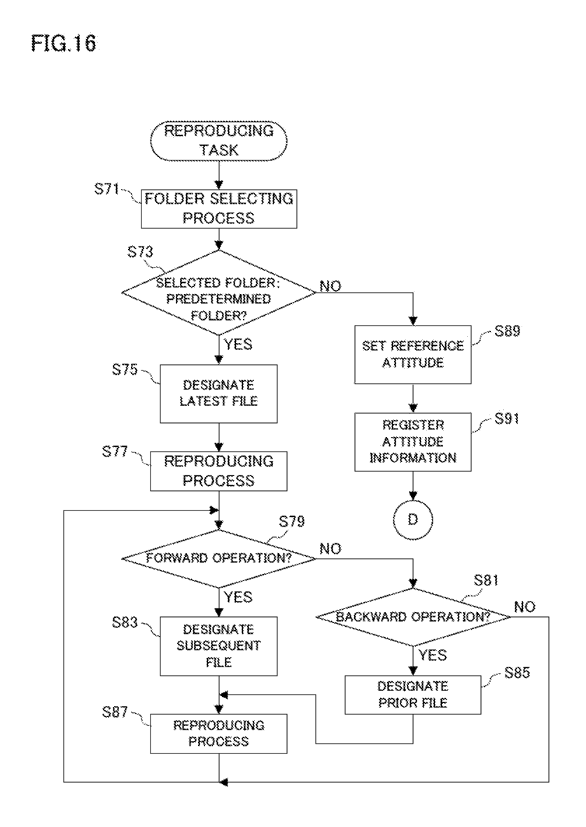

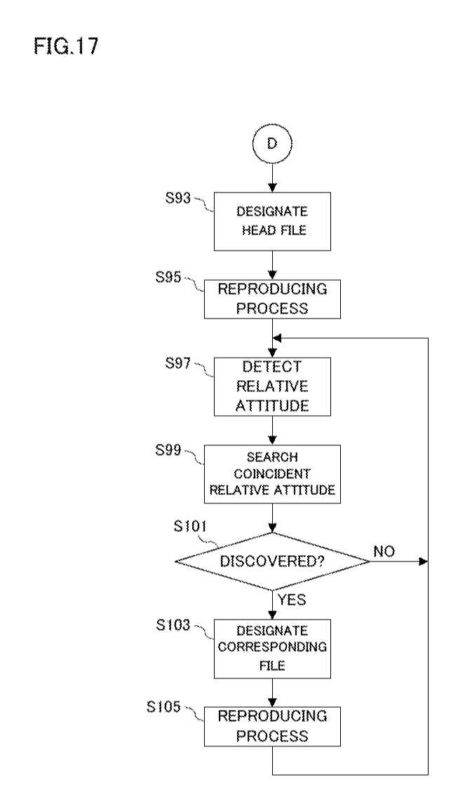

The CPU 34 executes the imaging task shown in FIG. 12 and the recording control task shown in FIG. 13 to FIG. 15 in a parallel manner when the camera mode is selected, and executes the reproducing task shown in FIG. 16 to FIG. 17 when the reproducing mode is selected. It is noted that the CPU 34 is a CPU which executes a plurality of tasks on a multi task operating system such as the μCITRON, in a parallel manner. Moreover, control programs equivalent to tasks executed by the CPU 34 are stored in a flash memory 48.

With reference to FIG. 12, in a step S1, the moving-image taking process is executed. As a result, a live view image representing a scene captured on the imaging surface is displayed on the LCD monitor 28. In a step S3, it is determined whether or not the shutter button 36sh is half-depressed, and as long as a determined result is NO, the simple AE process in a step S5 is repeatedly executed. As a result, a brightness of the live view image is adjusted approximately.

When the determined result of the step S3 is updated from NO to YES, in a step S7, the strict AE process and the AF process are executed. Thereby, a brightness of the live view image is adjusted strictly, and a sharpness of the live view image is improved. In a step S9, it is determined whether or not the shutter button 36sh is fully-depressed, and in a step S11, it is determined whether or not the operation of the shutter button 36sh is cancelled. When a determined result of the step S11 is YES, the process returns to the step S3, and when the determined result of the step S9 is YES, the process advances to a step S13.

In the step S13, the taking mode at a current time point is determined, and in a step S15, a state of the flag FLGerror is determined. When the taking mode at the current time point is the pseudo 3D mode and the flag FLGerror indicates “1”, the process returns to the step S9. When the taking mode at the current time point is the pseudo 3D mode and the flag FLGerror indicates “0”, or when the taking mode at the current time point is the normal mode, in a step S17, the still-image taking process is executed.

Image data representing a scene at a time point at which the shutter button 36sh is fully-depressed is evacuated from the moving-image area 24a to the still-image area 24b by the still-image taking process. Upon completion of the still-image taking process, the process returns to the step S3.

With reference to FIG. 13, in a step S21, it is determined whether or not the operation of selecting the pseudo 3D mode is performed by the mode selector switch 36md. When a determined result is NO, it is regarded that the taking mode at the current time point is the normal mode, and in a step S23, it is determined whether or not the shutter button 36sh is full-depressed.

When a determined result of the step S23 is NO, the process directly returns to the step S21 whereas when the determined result of the step S23 is YES, the process returns to the step S21 via processes in steps S25 to S27. In the step S25, a file header is created. In the step S27, created is an image file containing the file header created in the step S25 and the image data secured in the still-image area 24b by the process in the step S17 shown in FIG. 12, and the created image file is stored in the predetermined folder for the normal mode arranged in the recording medium 40.

When the determined result of the step S21 is YES, the process advances to a step S29. In the step S29, a pseudo 3D folder is newly created in the recording medium 40, and the created pseudo 3D folder is opened. In a step S31, the variable K indicating the number of image files contained in the pseudo 3D folder is set to “0”. In a step S33, it is determined whether or not the operation of selecting the normal mode is performed by the mode selector switch 36md, and when a determined result is YES, in a step S35, a value of the variable K is determined.

When the value of the variable K is “0”, it is regarded that no image file exists in the newly created pseudo 3D folder, and in a step S37, the pseudo 3D folder newly created in the recording medium 40 is deleted. On the other hand, when the value of the variable K is equal to or more than “1”, it is regarded that at least one image file exists in the pseudo 3D folder, and in a step S39, the pseudo 3D folder newly created in the recording medium 40 is closed. Upon completion of the process in the step S37 or S39, the process returns to the step S21.

When the determined result of the step S33 is NO, in a step S41, it is determined whether or not the shutter button 36sh is half-depressed. When a determined result is NO, the process returns to the step S33 whereas when the determined result is YES, the process advances to a step S43. In the step S43, the value of the variable K is determined, and the process advances to a step S45 corresponding to K=0 whereas advances to a step S49 corresponding to K≠0.

In the step S45, a horizontal angle and a vertical angle that define a current orientation of the camera housing CB1 is detected based on outputs of the geomagnetic sensor 42 and the gyro sensor 44, and the detected horizontal angle and vertical angle are registered as the reference attitude in the register RGST_R1. In a step S47, a distance to the main subject is calculated based on a placement of the focus lens 12 at a time point at which the AF process in the step S7 is completed, and the calculated distance is registered as the subject distance in the register RGST_R1. Upon completion of the process in the step S47, the process advances to a step S59.

In the step S49, change amounts of the horizontal angle and the vertical angle that define the attitude of the camera housing CB1 are detected based on the outputs of the geomagnetic sensor 42 and the gym sensor 44 and a description of the register RGST_R1, a change amount of a position of the camera housing CB1 is detected based on output of the acceleration sensor 46, and these detected change amounts are registered as the relative attitude in the register RGST_R2. The relative attitude is described in the K-th column.

In a step S51, a distance to the main subject is calculated based on a placement of the focus lens 12 at a time point at which the AF process in the step S7 is completed, and the calculated distance is registered as the subject distance in the register RGST_R2. The subject distance is also described in the K-th column.

In a step S53, it is determined whether or not a subject same as the main subject captured in the reference attitude is captured as a main subject at a time of operating the shutter button 36sh this time, based on the reference attitude and subject distance registered in the register RGST_R1 and the relative attitude and subject distance described in the K-th column of the register RGST_R2.

When a determined result is NO, in order to declare that the main subject captured in the K-th relative attitude is different from the main subject captured in the reference attitude, the flag FLGerror is se to “1” in a step S55. Upon completion of setting, the process returns to the step S33. On the other hand, when the determined result of the step S53 is YES, in order to declare that the main subject captured in the K-th relative attitude is common to the main subject captured in the reference attitude, the flag FLGerror is set to “0” in a step S57. Upon completion of setting, the process returns to the step S59.

In the step S59, it is determined whether or not the shutter button 36sh is full-depressed, and in a step S61, it is determined whether or not the operation of the shutter button 36sh is cancelled. When a determined result of the step S61 is YES, the process directly returns to the step S33, and when the determined result of the step S59 is YES, the process returns to the step S33 via processes in steps S63 to S67.

In the step S63, a file header is created. When a value of the variable K at a current time point is equal to or more than “1”, a relative attitude registered in the K+1th column of the register RGST_R2 is additionally written in the file header as the attitude information.

In the step S65, an image file containing the file header created in the step S63 and the image data secured in the still-image area 24b by the process in the step S17 shown in FIG. 12 is created, and the created image file is stored in the newly created pseudo 3D folder. Upon completion of storing, the variable K is incremented in the step S67, and thereafter, the process returns to the step S33.

With reference to FIG. 16, in a step S71, executed is a process of selecting any one of a plurality of folders recorded in the recording medium 40. In a step S73, it is determined which of the predetermined folder for the normal mode and the pseudo 3D folder created under the pseudo 3D mode is the selected folder. When the selected folder is the predetermined folder, the process advances to a step S75 whereas when the selected folder is the pseudo 3D folder, the process advances to a step S89.

In the step S75, the latest image file contained in the predetermined folder is designated, and in a step S77, the memory I/F 38 is commanded to reproduce the designated image file.

The memory I/F 38 reads out the image data contained in the designated image file from the recording medium 40 so as to write the read-out image data into the still-image area 24b of the SDRAM24 through the memory control circuit 22. The LCD driver 26 reads out the image data thus transferred to the still-image area 24b through the memory control circuit 22 so as to drive the LCD monitor 28 based on the read-out image data. As a result, a reproduced image is displayed on the monitor screen.

In a step S79, it is determined whether or not the forward operation is performed by the forward/backward button 36fr, and in a step S81, it is determined whether or not the backward operation is performed by the forward/backward button 36fr. When a determined result of the step S79 is YES, the subsequent image file contained in the predetermined folder is designated in a step S83. On the other hand, when a determined result of the step S81 is YES, the prior image file contained in the predetermined folder is designated in a step S85.

In a step S87, the memory I/F 38 is commanded to reproduce the image files thus designated. As a result, the image displayed on the LCD monitor 28 is updated to another image. Upon completion of the process in the step S87, the process returns to the step S79.

In the step S89, a horizontal angle and a vertical angle that define a current orientation of the camera housing CB1 is detected based on outputs of the geomagnetic sensor 42 and the gym sensor 44, and the detected horizontal angle and vertical angle are registered as the reference attitude in the register RGST_P1. In a step S91, attitude information (=relative attitude) is read out from the second and subsequent image files contained in the pseudo 3D folder so as to register the read-out attitude information in the register RGST_P2.

In a step S93, the head image file contained in the pseudo 3D folder is designated, and in a step S95, the memory I/F 38 is commanded to reproduce the designated image file. As a result, a reproduced image that is based on the image data contained in the head image file is displayed on the LCD monitor 28.

In a step S97, change amounts of the horizontal angle and the vertical angle that define the attitude of the camera housing CB1 is detected based on the outputs of the geomagnetic sensor 42 and the gyro sensor 44 and a description of the register RGST_P1, a change amount of a position of the camera housing CB1 is detected based on output of the acceleration sensor 46, and these detected change amounts are defined as a relative attitude at a current time point.

In a step S99, a relative attitude coincident with the defined relative attitude at the current time point is searched from among one or at least two relative attitudes registered in the register RGST_P2. In a step S101, it is determined whether or not the coincident relative attitude is discovered, and when a determined result is NO, the process directly returns to the step S97 whereas when the determined result is YES, the process returns to the step S97 via processes in steps S103 to S105. In the step S103, an image file of description resource of the discovered relative attitude is designated, and in the step S105, the memory I/F 38 is commanded to reproduce the designated image file. As a result, the image displayed on the LCD monitor 28 is updated to another image.

As can be seen from the above-described explanation, the imaging device 16 outputs the raw image data corresponding to the optical image captured on the imaging surface, and the signal processing circuit 20 coverts the outputted raw image data in the YUV formatted-image data. The CPU 34 acquires the image data outputted from the signal processing circuit 20, in response to the operation of the shutter button 36sh (=the user operation) (S3, S9 and S17). However, permitting/restricting the acquiring process is controlled by determining the commonality between the main subject captured by the imaging surface at a time point at which the operation of the shutter button 36sh is accepted and the main subject captured by the imaging surface in the reference attitude (S41, S49 to S57 and S15). When the acquiring process is permitted, the CPU 34 creates the attitude information indicating the attitude of the imaging surface at the time point at which the operation of the shutter button 36sh is accepted (S63). The acquired image data is reproduced with reference to the attitude information thus created (S89 to S105).

The process of acquiring the image data in response to the operation of the shutter button 36sh is permitted/restricted by determining the commonality between the main subject captured by the imaging surface at the time point at which the operation of the shutter button 36sh is accepted and the main subject captured by the imaging surface in the reference attitude. Thereby, it becomes possible to restrictively acquire the image data in which the common subject is appeared, and the recording performance is improved. Moreover, the attitude information indicating the attitude of the imaging surface at the time point at which the operation of the shutter button 36sh is accepted is created in association with acquiring the image data, and the acquired image data is reproduced with reference to the created attitude information. Thereby, the reproducing performance is improved.

It is noted that, in this embodiment, the attitude of the camera housing CB1 is detected in the reproducing mode so as to reproduce an image file different depending on the detected attitude (see the steps S97 to S105 shown in FIG. 17). However, instead of the attitude of the camera housing CB1, an attitude of a face portion of a person existing in front of the monitor screen may be detected so as to reproduce the image file different depending on the detected attitude.

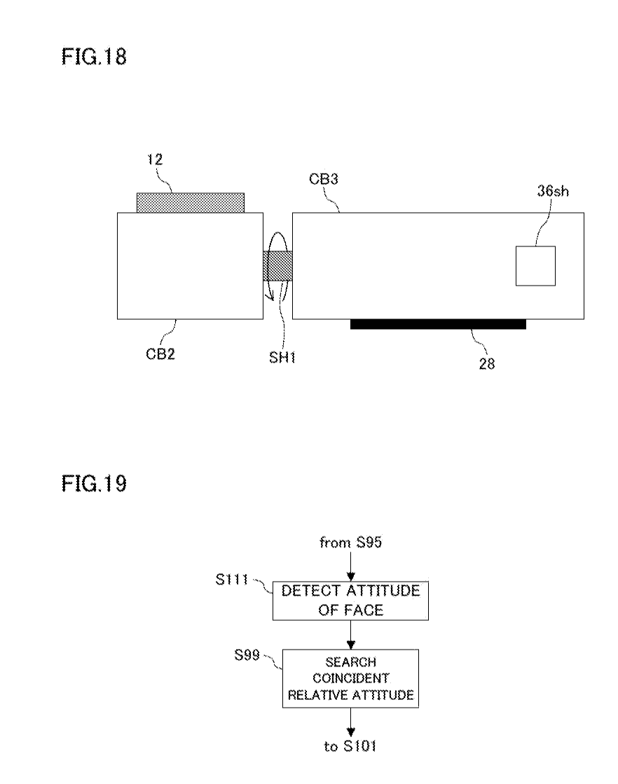

In this case, preferably, two camera housings CB2 and CB3 shown in FIG. 18 are prepared. According to FIG. 18, the focus lens 12 is arranged on a front surface of the camera housing CB2, the LCD monitor 28 is arranged on a rear surface of the camera housing CB3, and the camera housings CB2 and CB3 are combined by a shaft SH1. Thereby, an orientation of the focus lens 12, i.e., an orientation of the imaging surface becomes switchable between the front and rear of the camera housing CB3.

The reproducing mode is activated in a state where the imaging surface is directed to the rear of the camera housing CB3, and the CPU 34 executes a process in a step S111 shown in FIG. 19 instead of the step S97 shown in FIG. 17. In the step S111, an attitude of a face of a person (=a user) existing in front of the LCD monitor 28 is detected based on the output of the imaging device 16. The detected attitude is reflected in the process in the step S99.

Moreover, upon controlling designating an image file to be reproduced, the attitude of the camera housing CB1 and the attitude of the face portion of the person existing in front of the monitor screen may be detected in a parallel manner so as to update designating the image file in response to a change of one of the attitudes.

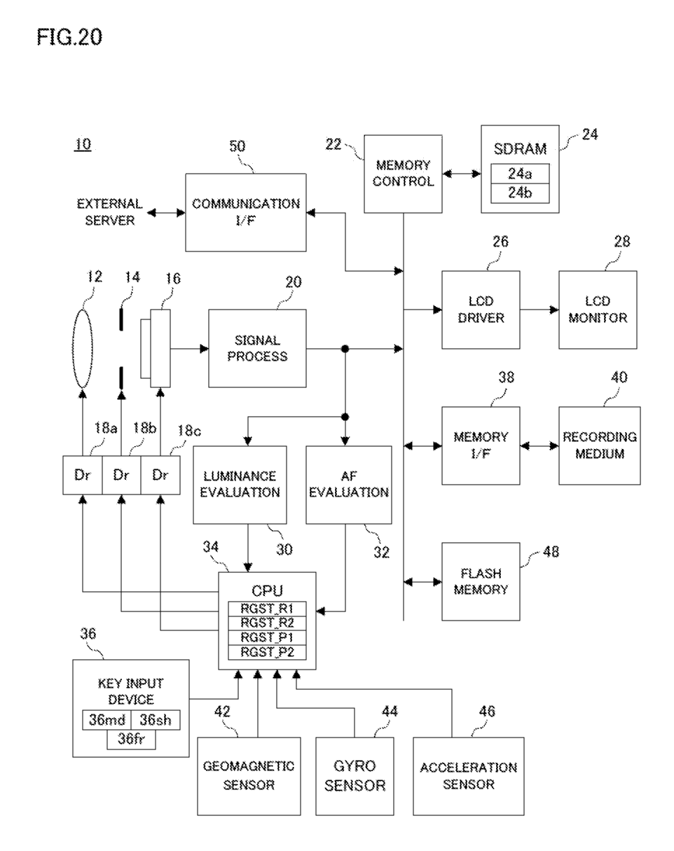

Furthermore, in this embodiment, the control programs equivalent to the multi task operating system and a plurality of tasks executed thereby are previously stored in the flash memory 48. However, a communication I/F 50 may be arranged in the digital camera 10 as shown in FIG. 20 so as to initially prepare a part of the control programs in the flash memory 48 as an internal control program whereas acquire another part of the control programs from an external server as an external control program. In this case, the above-described procedures are realized in cooperation with the internal control program and the external control program.

Moreover, in this embodiment, the processes executed by the CPU 34 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which outputs an electronic image corresponding to an optical image captured on an imaging surface;
an acquirer which acquires the electronic image outputted from said imager, in response to a user operation;
a controller which controls permitting/restricting a process of said acquirer by determining a commonality between an object captured by said imaging surface at a time point at which the user operation is accepted and an object captured by said imaging surface in a reference attitude;
a creator which creates attitude information indicating an attitude of said imaging surface at the time point at which the user operation is accepted when the process of said acquirer is permitted by said controller; and
a reproducer which reproduces the electronic image acquired by said acquirer with reference to the attitude information created by said creator.

2. An electronic camera according to claim 1, wherein said controller includes a permitter which permits the process of said acquirer when two objects to be noticed are common, and a restrictor which restricts the process of said acquirer when the two objects to be noticed are different.

3. An electronic camera according to claim 1, further comprising a focus lens which is placed on a front of said imaging surface, wherein said acquirer includes an adjuster which adjusts a distance from said focus lens to said imaging surface in response to the user operation, and said controller includes a determiner which determines the commonality with reference to the attitude of said imaging surface and the distance adjusted by said adjuster.

4. An electronic camera according to claim 1, wherein said reproducer includes a detector which detects an attitude of a specific object, a comparer which compares the attitude detected by said detector with the attitude information created by said creator, and an image reproducer which reproduces an electronic image different depending on a compared result of said comparer.

5. An electronic camera according to claim 4, wherein the specific object is equivalent to a camera housing.

6. An electronic camera according to claim 4, further comprising a displayer which displays the electronic image reproduced by said reproducer on a monitor screen, wherein the specific object is equivalent to a face of a person existing in front of said monitor screen.

7. A camera control program recorded on a non-transitory recording medium in order to control an electronic camera provided with an imager which outputs an electronic image corresponding to an optical image captured on an imaging surface, the program causing a processor of the electronic camera to perform the steps, comprising:
an acquiring step of acquiring the electronic image outputted from said imager, in response to a user operation;
a controlling step of controlling permitting/restricting a process of said acquiring step by determining a commonality between an object captured by said imaging surface at a time point at which the user operation is accepted and an object captured by said imaging surface in a reference attitude;
a creating step of creating attitude information indicating an attitude of said imaging surface at the time point at which the user operation is accepted when the process of said acquiring step is permitted by said controlling step; and
a reproducing step of reproducing the electronic image acquired by said acquiring step with reference to the attitude information created by said creating step.

8. A camera control method executed by an electronic camera provided with an imager which outputs an electronic image corresponding to an optical image captured on an imaging surface, comprising:
an acquiring step of acquiring the electronic image outputted from said imager, in response to a user operation;
a controlling step of controlling permitting/restricting a process of said acquiring step by determining a commonality between an object captured by said imaging surface at a time point at which the user operation is accepted and an object captured by said imaging surface in a reference attitude;
a creating step of creating attitude information indicating an attitude of said imaging surface at the time point at which the user operation is accepted when the process of said acquiring step is permitted by said controlling step; and
a reproducing step of reproducing the electronic image acquired by said acquiring step with reference to the attitude information created by said creating step.
